(19) United States
(12) Patent Application Publication
(10) Pub. No.: US 2026/0365589 A1
(43) Pub. Date: Nov. 19, 2026

(54) METHOD FOR PROTECTING A CARBON/CARBON COMPOSITE MATERIAL PART FROM OXIDATION

(71) Applicant: SAFRAN LANDING SYSTEMS, VELIZY-VILLACOUBLAY (FR)

(72) Inventors: Julien SNIEZEWSKI, MOISSY-CRAMAYEL (FR); Fanny ALOUSQUE, MOISSY-CRAMAYEL (FR); Véronique FONTARNOU, MOISSY-CRAMAYEL (FR)

(21) Appl. No.: 19/749,087

(22) Filed: Jul. 21, 2026

Related U.S. Application Data
(63) Continuation-in-part of application No. 18/688,033, filed on Aug. 29, 2022.

(30) Foreign Application Priority Data
Sep. 2, 2021 (FR) 2109171

(51) Int. Cl. C04B 41/50; C04B 41/00; C04B 41/45; C04B 41/52; C04B 41/86; C04B 41/89; F16D 69/02

(52) U.S. Cl. CPC C04B 41/5092; C04B 41/0072; C04B 41/009; C04B 41/4533; C04B 41/5022; C04B 41/52; C04B 41/86; C04B 41/89; F16D 69/023; F16D 2200/0047; F16D 2200/0091

(57) ABSTRACT

A method for protecting a carbon/carbon composite material part from oxidation, the method including applying onto at least a portion of an external surface of the part an impregnation composition comprising mono-aluminium phosphate Al(H₂PO₄)₃; preliminary heat treating the thus applied impregnation composition to form an adhesion-promoting layer chemically bonded to the carbon/carbon composite material part and comprising a [A] allotropic form of Al(PO₃)₃; and dry depositing, after performing the preliminary heat treatment, onto at least a portion of the adhesion-promoting layer a solid oxidation-resistant glass composition; the oxidation-resistant glass being chemically bonded to the adhesion-promoting layer comprising the [A] allotropic form of Al(PO₃)₃.

### CROSS-REFERENCE TO RELATED APPLICATIONS

This application is a continuation-in-part of application Ser. No. 18/688,033 filed on Feb. 29, 2024, which is the U.S. National Stage of PCT/FR2022/051621, filed Aug. 29, 2022, which in turn claims priority to France patent application number 2109171 filed Sep. 2, 2021. The content of these applications are incorporated herein by reference in their entireties.

### FIELD

The invention relates to the field of carbon/carbon composite material parts, and more specifically to methods for protecting such parts from oxidation.

### BACKGROUND

The invention relates to the protection from oxidation of carbon/carbon composite material parts, i.e., a material comprising a fibrous reinforcement densified by a matrix in which the fibrous reinforcement and the matrix comprise carbon. A particular field of application of the invention is the protection from oxidation of C/C composite brake discs, and, in particular, of brake discs for aircraft, for example airplanes, or of brake discs for land vehicles.

In an oxidizing environment, the ability of such parts to maintain good mechanical properties at high temperatures is subject to the presence of effective protection from carbon oxidation. Indeed, after its creation, the composite material usually has residual internal porosity which provides the ambient environment with access to the core of the material.

Additionally, in some applications, oxidation protection must maintain its effectiveness in the presence of moisture and/or carbon oxidation catalysts. This is particularly the case for C/C composite aircraft brake discs which can be exposed to moisture present on runways and come into contact with carbon oxidation catalysts introduced, for example, by potassium acetates or formates present in de-icing products commonly used on runways.

Protection from oxidation of such parts is generally provided by coatings deposited on the carbon/carbon composite material parts. However, such external coatings are sensitive to mechanical degradation caused by the friction, impact and vibrations inevitable for such parts.

Introducing a layer of oxidation protection into the internal porosity of the composite material parts has also been considered to overcome such disadvantages. For example, documents FR 2,726,554 and EP 3,072,866 describe methods for protecting a carbon/carbon composite material part from oxidation obtained using aqueous compositions making it possible to form, after a heat treatment, protection from oxidation in the internal porosity of the part.

However, it is desirable to improve the resistance to oxidation of such parts in order to increase their lifespan.

### SUMMARY

The inventors have noted that it is possible to improve the homogeneity of the protective layer formed in the porosity of the part, while increasing the deposition yields and further improving the oxidation resistance properties of carbon/carbon composite material parts.

According to a first aspect, the inventors propose a method for protecting a carbon/carbon composite material part from oxidation, the method comprising at least the following steps:
the application onto at least a portion of the external surface of the part of an impregnation composition comprising at least one metal phosphate;
the dry deposition, after application of the impregnation composition, onto at least a portion of the external surface of the part of a solid oxidation-resistant glass composition; and
an impregnation heat treatment in order to soften or melt the dry deposited solid composition, to allow the impregnation of the internal porosity of the part by the composition thus softened or melted, and to form an oxidation-resistant glass in the internal porosity of the part.

The inventors have noted that such a protection method allows the formation of a barrier against oxidation in the internal porosity of the part. It is advantageous for the protection to be present in the internal porosity since it is thus not subject to the impacts or friction that the part may undergo.

Furthermore, unlike the protection methods considered in the prior art, the solid composition of a protective glass is deposited dry.

It is understood by “dry deposition” that the method of the invention does not require the use of a third carrier liquid during the deposition of the solid composition and its infiltration into the internal porosity, unlike the deposition methods of the prior art which use slurries.

The choice of the dry method for deposition of the solid composition makes it possible to obtain, after an impregnation heat treatment, an oxidation-resistant glass directly in the internal porosity of the part with an increased deposition yield compared to the deposit methods of the prior art. In addition, the glass obtained is more homogeneous than with methods requiring carrier liquids for the solid composition.

In a dry deposition method, the solid composition can be sprayed in a liquid, solid or pasty form, without a third carrier liquid, and it forms a solid deposit once its deposition is completed.

For example, the dry deposition of the solid composition is carried out by electrostatic spraying, by thermal spraying of powder at high speed or even by cold spraying. The dry deposition of the solid composition may be carried out by atmospheric plasma spraying.

It is understood within the meaning of the invention that the impregnation of the internal porosity of the part should be understood as a deep impregnation of the internal porosity, i.e., that the oxidation-resistant glass is not only formed on the surface of the part, but extends from the surface deep into the part into its internal porosity.

For example, impregnation heat treatment allows the formation of an oxidation-resistant glass to a depth greater than or equal to 0.5 mm, measured from the external surface of the part.

In one embodiment, the oxidation-resistant glass can be formed in the internal porosity of the part and throughout its thickness.

In one embodiment, the method may comprise a preliminary heat treatment step at a temperature comprised between 680 °C and 740 °C, carried out after the impregnation composition application step and before the solid composition deposition step.

Such a preliminary heat treatment makes it possible to increase the impregnation of the internal porosity of the part by the impregnation composition before the formation of the oxidation-resistant glass.

The preliminary heat treatment allows the impregnation composition to further impregnate the internal porosity of the part and to form a layer therein for trapping carbon oxidation catalysts, and thus improves the oxidation resistance of the part. In addition, the presence of the impregnation composition allows better impregnation of the internal porosity of the preform by the solid composition.

According to the first aspect, this preliminary heat treatment is not necessary, however, and the application of the impregnation composition can be followed directly by the dry deposition of the solid composition. If this is the case, the impregnation composition and the solid composition are then both present, and possibly mixed, in the porosity of the part, and the impregnation heat treatment carried out after the deposition of the solid composition will allow a single step of impregnating the internal porosity of the part with the impregnation composition and forming there the oxidation-resistant glass and a layer for trapping carbon oxidation catalysts.

For example, the solid composition can be a glass powder composed of a plurality of particles, the mean size of which is less than or equal to 10 μm. Unless otherwise stated, “mean size” refers to the dimension given by the statistical particle size distribution at half of the population, called D50.

The duration and temperature of the heat treatment which make it possible to soften or melt the solid composition are chosen according to the physicochemical nature of the solid composition. In particular, the impregnation heat treatment must allow the solid composition of an oxidation-resistant glass to become sufficiently soft or even melt so that it can impregnate the internal porosity of the part.

In a particular embodiment where the solid composition comprises a phosphate or silicate glass powder, the impregnation heat treatment is carried out at a temperature comprised between 680 °C and 1100 °C, and, for example, for a duration comprised between 1 minute and 2 hours.

For example, the heat treatment can be carried out by flash heat treatment, or by introduction into an oven.

In one embodiment, the method may comprise, after the impregnation heat treatment step, at least the following steps:
the dry deposition onto at least a portion of the external surface of the part of a second solid composition of an oxidation-resistant glass identical or different to the solid composition; then
a second impregnation heat treatment in order to soften or melt the second solid composition deposited dry, to allow the impregnation of the internal porosity of the part by the second composition thus softened or melted, and to form a second oxidation-resistant glass in the internal porosity of the part.

These additional steps make it possible to further improve the resistance to oxidation of the parts obtained, not only compared to those obtained with the methods of the prior art, but also compared to those obtained after the deposition of a single solid composition.

In one embodiment, the solid composition is the same for the first and second dry deposition steps. In another embodiment, the first and second solid compositions may be different.

The choice of identical or different solid compositions makes it possible to further improve the oxidation resistance properties of the parts obtained and to adapt them particularly to the external conditions encountered by the part during its final use.

In one embodiment, the method comprises, after the second impregnation heat treatment step, at least the following steps:
the dry deposition onto at least a portion of the external surface of the part of a third solid composition of an oxidation-resistant glass identical or different to the first and/or the second solid composition; then
a third impregnation heat treatment in order to soften or melt the third solid composition deposited dry, to allow the impregnation of the internal porosity of the part by the third composition thus softened or melted, and to form a third oxidation-resistant glass in the internal porosity of the part.

In this embodiment, the first, second and third compositions may be identical or different. It is also possible that two of the three compositions are identical, and the other is different.

An embodiment comprising three steps of deposition of a solid composition makes it possible to further improve the resistance to oxidation of parts obtained by the method described.

In particular, it is observed that a quantity of solid composition deposited and impregnated in two or three successive steps rather than in a single step makes it possible to obtain a final part whose resistance to oxidation is even better.

In one embodiment, the total quantity of solid composition deposited onto at least a portion of the external surface of the part during the dry deposition step or steps can be greater than or equal to 2 mg/cm², or even greater than or equal to 5 mg/cm². This quantity may be comprised between 2 mg/cm² and 10 mg/cm², or between 5 mg/cm² and 10 mg/cm².

Such quantities of solid composition make it possible to obtain resistance to oxidation greater than that of parts obtained by the methods of the prior art.

In one embodiment, the solid oxidation-resistant glass composition(s) can be chosen from phosphate or silicate glass powders.

In one embodiment, the solid oxidation-resistant glass composition may comprise, in mass percentages:
42 to 47% phosphorus pentoxide P₂O₅;
8 to 11% potassium oxide K₂O;
14 to 18% sodium oxide Na₂O;
14 to 18% aluminium oxide Al₂O₃;
7 to 10% boron sesquioxide B₂O₃.

In one embodiment, the solid oxidation-resistant glass composition may comprise, in mass percentages:
37 to 41% phosphorus pentoxide P₂O₅;
16 to 20% potassium oxide K₂O;
10 to 13% sodium oxide Na₂O;
16 to 19% aluminium oxide Al₂O₃;
7.5 to 10.5% boron sesquioxide B₂O₃.

In one embodiment, the carbon/carbon composite material part is a friction part, for example, an aircraft brake disc. For example, the carbon/carbon composite material part comprises a carbon fiber reinforcement and a pyrocarbon matrix densifying said carbon fiber reinforcement.

According to a second aspect, the inventors propose a method for protecting a carbon/carbon composite material part from oxidation, the method comprising:
applying onto at least a portion of an external surface of the part an impregnation composition comprising mono-aluminium phosphate Al(H₂PO₄)₃;
preliminary heat treating the thus applied impregnation composition to form an adhesion-promoting layer chemically bonded to the carbon/carbon composite material part and comprising a [A] allotropic form of Al(PO₃)₃; and
dry depositing, after performing the preliminary heat treatment, onto at least a portion of the adhesion-promoting layer a solid oxidation-resistant glass composition; said oxidation-resistant glass being chemically bonded to the adhesion-promoting layer comprising the [A] allotropic form of Al(PO₃)₃.

According to the second aspect, the preliminary heat treatment is performed to form a Al(PO₃)₃ [A] phase, which improves wetting and bonding of the glass and confer excellent adhesion of the glass to the substrate. The preliminary heat treatment of the thus applied impregnation composition forms an adhesion-promoting layer chemically bonded to the carbon/carbon composite material part and comprising a [A] allotropic form of Al(PO₃)₃. The presence of this allotropic form of Al(PO₃)₃ can be verified by Nuclear Magnetic Resonance (NMR) (21.5 ppm resonance on the ²⁷Al and −50.6 ppm resonance on the ³¹P spectrum).

According to the second aspect, the impregnation heat treatment described above is not necessary, and therefore may or may not be carried out.

In an embodiment, the mono-aluminium phosphate Al(H₂PO₄)₃ applied to the external surface of the part has a P/Al atomic ratio that is greater than 3, for example that is greater than or equal to 3.2.

The mono-aluminium phosphate Al(H₂PO₄)₃ applied to the external surface of the part may have a P/Al atomic ratio that is greater than 3, notably greater than 3 and less than 3.7. This P/Al atomic ratio may be greater than or equal to 3.2, notably comprised between 3.2 and 3.7.

The impregnation composition may comprise the mono-aluminium phosphate Al(H₂PO₄)₃ in the range of 40% to 60% by weight, for example in the range of 45% to 55% by weight, for example at about 50% by weight. The remainder of the impregnation composition may be water. The impregnation composition may essentially comprise the mono-aluminium phosphate Al(H₂PO₄)₃ and water.

According to the second aspect, a temperature comprised between 680 °C and 900 °C is applied during the preliminary heat treatment, for example this temperature is comprised between 700 °C and 850 °C or between 700 °C and 750 °C. This temperature may be comprised between 680 °C and 850 °C or between 680 °C and 750 °C.

The preliminary heat treatment may be carried out under an inert atmosphere.

The duration of the preliminary heat treatment may be comprised between 30 minutes and 2 hours, for example between 1 hour and 2 hours.

In an embodiment, a quantity of mono-aluminium phosphate Al(H₂PO₄)₃ deposited on the external surface of the part is greater than or equal to 15 mg/cm², for example is comprised between 15 mg/cm² and 25 mg/cm².

In an embodiment, a quantity of the [A] allotropic form of Al(PO₃)₃ formed onto the external surface of the part, after the preliminary heat treatment, is greater than or equal to 6 mg/cm², for example is comprised between 6 mg/cm² and 11 mg/cm².

The techniques described in connection with the first aspect may be carried out for dry depositing the solid composition in relation with the second aspect. The same quantities of solid composition may be deposited as in the first aspect, the same type of solid compositions may be used and the same type of parts may be coated.

### BRIEF DESCRIPTION OF THE DRAWINGS

FIG. 1 schematically represents a method in a first embodiment of the first aspect.

FIG. 2 schematically represents a method in a second embodiment of the first aspect.

FIG. 3 represents the results obtained for the evolution of the mass loss as a function of time of the samples prepared according to one example.

FIG. 4 shows a cross-section of a protection coating according to an embodiment of the invention.

FIG. 5 shows a cross-section of a coating outside the scope of the invention.

### DETAILED DESCRIPTION

The invention will now be described by means of figures illustrating particular embodiments of the invention which are present only for illustrative purposes in order to better understand the invention, and which should not be interpreted as limiting the invention.

FIG. 1 represents a diagram of a method of carrying out the invention according to the first aspect.

Such a method comprises a first step 10 of application onto at least a portion of the external surface of the part of an impregnation composition comprising at least one metal phosphate.

In one example of embodiment, the metal phosphate is an aluminium phosphate. As a variant, a manganese, zinc, calcium or magnesium phosphate could be used, with or without phosphoric acid. In one embodiment, the metal phosphate is mono-aluminium phosphate Al(H₂PO₄)₃. In other embodiments, complex phosphates may also be used, for example, complex aluminium and calcium phosphates.

The impregnation composition makes it possible, after impregnation in the internal porosity, to form a layer for trapping carbon oxidation catalysts therein, and thus to improve the resistance to oxidation.

Indeed, it is known that phosphates make it possible to oppose the effect of catalytic agents of carbon oxidation, and in particular of alkaline or alkaline earth elements.

The impregnation composition can be applied by brush, by atomisation or by spraying onto an external surface of the part.

In one embodiment, the quantity of impregnation composition deposited during step 10 may be greater than or equal to 6.0 mg/cm², or even greater than or equal to 8.0 mg/cm².

The quantity of impregnation composition deposited is expressed as a function of the surface area of the part covered in order to be able to compare the oxidation resistance properties observed for parts with different surfaces. The same will be done for the quantities of solid compositions described below.

As indicated in FIG. 1, step 10 of applying the impregnation composition can be followed by a preliminary heat treatment step 20 preferably carried out under an inert atmosphere, for example at a temperature comprised between 680 °C and 740 °C in the context of the first aspect.

Such a preliminary heat treatment step 20 allows the impregnation composition to impregnate the internal porosity of the part and to form a layer therein for trapping carbon oxidation catalysts, and thus improves the oxidation resistance of the part.

However, step 20 is not necessary according to the first aspect, because the impregnation heat treatment 40 which will be described below makes it possible, in the case where step 20 is not carried out, to obtain in a single heat treatment both the impregnation of the internal porosity of the part by the impregnation composition and by the oxidation-resistant glass composition.

Whether the preliminary heat treatment 20 is carried out or not, the method then comprises, according to the first aspect, a step of dry deposition of a solid oxidation-resistant glass composition 30 followed by an impregnation heat treatment step 40. The combination of steps 30 and 40 allows both the impregnation of the internal porosity of the part with the softened or melted protective glass composition, and the formation in the internal porosity of the part of an oxidation-resistant glass. The oxidation-resistant glass thus formed in the internal porosity of the part acts as an oxygen diffusion barrier and therefore makes it possible to limit the oxidation of the composite material part.

The heat treatment 40 can be carried out under vacuum or under pressure.

In one embodiment where the impregnation heat treatment 40 allows the solid composition to melt, capillary phenomena make it possible to further improve the impregnation of the internal porosity of the part by the molten composition.

The combination of the layer obtained by means of the impregnation composition and the softened or melted protective glass composition makes it possible to produce, directly in the internal porosity of the part, an oxidation protection coating combining the role of a trap for carbon oxidation catalysts and an oxygen diffusion barrier.

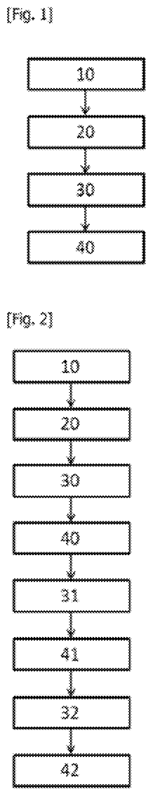

FIG. 2 illustrates a method according to another embodiment according to the first aspect.

This method comprises steps 10, 20, 30 and 40 identical to those described previously.

In particular, and as described above, step 20 is optional in the method illustrated in FIG. 2.

The method described in FIG. 2 further comprises a step 31 of depositing a second solid composition, identical or different to the solid composition deposited during step 30.

The method then comprises a second heat treatment step 41 making it possible to obtain the same effects as the impregnation heat treatment, for the second solid composition deposited during step 31.

For example, if the solid composition used for step 31 is the same as for step 30, the second impregnation heat treatment 41 may be identical to the impregnation heat treatment 40. However, when the solid compositions of steps 30 and 31 are different, the durations and/or temperatures of the heat treatments 40 and 41 may be different.

The method of FIG. 2 then comprises a step of dry deposition of a third solid composition 32.

The solid composition deposited by dry method during step 32 may be identical or different to that of step 30 and/or that of step 31.

The method described in FIG. 2 then comprises a third heat treatment step 42 making it possible to obtain the softening or melting of the third solid composition, its impregnation into the internal porosity of the part and the formation of a third oxidation-resistant glass.

The third heat treatment makes it possible to obtain the same effects as the impregnation heat treatment 40 described above, but for the third solid composition. It is also possible, according to an embodiment not illustrated, that a method comprises a step of applying an impregnation composition 10, possibly a preliminary heat treatment 20, the dry deposition of a solid oxidation-resistant glass composition 30, an impregnation heat treatment 40, the dry deposition of a second solid oxidation-resistant glass composition 31 and a second heat treatment 41; these steps can each be carried out as described above.

In carrying out the methods described, the quantity of total solid composition deposited may be greater than or equal to 3.0 mg/cm², or even greater than or equal to 6.0 mg/cm².

In embodiments comprising the dry deposition of a single solid composition, the quantity of solid composition deposited may be comprised between 2.0 and 10.0 mg/cm², or even between 3.0 and 8.0 mg/cm².

### Examples

The effect of a protective coating obtained by a method according to the first aspect is now described by means of particular examples, which should not be considered as limiting the invention.

Carbon/carbon composite material parts protected from oxidation were prepared from a carbon/carbon composite material part by a method comprising a step of depositing a metal phosphate impregnation composition. The impregnation composition is an aqueous solution of aluminium dihydrogen phosphate concentrated at 50% by weight. This solution is, for example, available under the trade name “aluminum dihydrogen phosphate 50%” from the company Alfa.

One or more solid compositions of composition P1 or P2 were then deposited by dry method onto a surface of the sample, a heat treatment being applied after each dry deposition step. The heat treatment is carried out at a temperature of 700 °C for 1 hour and 30 minutes.

The solid composition called P1 comprises:
42 to 47% phosphorus pentoxide P₂O₅;
8 to 11% potassium oxide K₂O;
14 to 18% sodium oxide Na₂O;
14 to 18% aluminium oxide Al₂O₃;
7 to 10% boron sesquioxide B₂O₃.

The solid composition called P2 comprises:
37 to 41% phosphorus pentoxide P₂O₅;
16 to 20% potassium oxide K₂O;
10 to 13% sodium oxide Na₂O;
16 to 19% aluminium oxide Al₂O₃;
7.5 to 10.5% boron sesquioxide B₂O₃.

Table 1 describes the nature and quantity of the various solid compositions deposited onto each of the samples.

TABLES 1

| | Metal | | | |
|---|---|---|---|---|
| | phosphate | | | |
| | impregnation | First solid | Second solid | Third solid |
| Sample | composition | composition | composition | composition |
| A | 8.2 mg/cm² | P1 6.1 mg/cm² | | |
| B | 8.1 mg/cm² | P1 3.1 mg/cm² | P1 7.9 mg/cm² | |
| C | 8.2 mg/cm² | P1 2.1 mg/cm² | P1 2.1 mg/cm² | P1 1.6 mg/cm² |
| D | 8.2 mg/cm² | P2 6.2 mg/cm² | | |
| E | 8.0 mg/cm² | P2 3.7 mg/cm² | P2 4.8 mg/cm² | |
| F | 8.2 mg/cm² | P2 2.4 mg/cm² | P2 2.1 mg/cm² | P2 1.6 mg/cm² |
| G | 8.0 mg/cm² | P1 2.8 mg/cm² | P2 0.4 mg/cm² | |

The resistance to oxidation is then determined by weighing the samples after:
8 hours at 650 °C in air, then
3 hours at 850 °C in air, then
5 min at 1000 °C in air, then
2 hours at 650 °C in air.

The resistance to oxidation of samples A to G obtained according to the invention is compared between the samples and also with parts obtained by prior art methods.

For this, a sample was obtained according to the method described in document FR 2,726,554 (reference 1) and another according to the method described in document U.S. Pat. No. 9,758,678 (reference 2) which differ from the invention.

Reference 1 is obtained by impregnating a carbon/carbon composite material part with an aqueous solution of aluminium dihydrogen phosphate Al(H₂PO₄)₃ concentrated at 50% by weight applied by brush. The impregnation is followed by a heat treatment at 700 °C for 5 hours.

Reference 2 is obtained by impregnating a carbon/carbon composite material part in a manner similar to that of reference 1 above. This treatment provides an internal layer of protection. The part is then coated with an external layer obtained by applying with a brush or by thermal spraying a composition comprising, in mass:
67% of aqueous solution of mono-aluminium phosphate at 50% by weight of water;
16.3% of B₄ C powder with at most 2% of impurities, the particles of the powder having a size less than 7.5 μm;
11% dry titanium powder with a particle size comprised between 150 μm and 20 μm;
4.7% water;
1% of a solution with the commercial name “Surfynol® 440”.

The oxidation resistance is then determined by weighing the samples after the same steps as those described for samples A to G.

Table 2 and FIG. 3 describe the oxidation resistance results obtained for samples A to G according to the invention, compared to reference samples 1 and 2.

TABLES 2

| Sample | Mass | Gain compared | Gain compared |
|---|---|---|---|
| (curve FIG. 3) | loss | to reference 1 | to reference 2 |
| reference 1 (201) | 15.8% | — | — |
| reference 2 (202) | 4.1% | 74% | — |
| A (203) | 7.7% | 23% | — |
| B (204) | 3.7% | 63% | 10% |
| C (205) | 1.8% | 82% | 55% |
| D (206) | 4.2% | 58% | — |
| E (207) | 2.4% | 76% | 42% |
| F (208) | 1.6% | 84% | 60% |
| G (209) | 3% | 70% | 26% |

As can be observed in FIG. 3 and in Table 2, the method according to the first aspect of the invention makes it possible to increase the resistance to oxidation of the parts compared to reference 1 even when a single solid composition is deposited.

In Table 1, the symbol “---” indicates that the layer is less efficient than the reference, in the sense that the mass loss is greater. For example, samples A and D have greater mass losses than reference 2. They nevertheless have better oxidation resistance than reference 1.

Furthermore, the comparison of samples A and C or D and F shows that it is advantageous to deposit a given quantity of solid composition in several steps rather than in a single step in order to obtain better resistance to oxidation.

In addition, sample G shows that the use of two different solid compositions makes it possible to obtain oxidation resistance properties better than according to the prior art, and comparable to those obtained for samples where two identical solid compositions have been deposited.

Furthermore, sample G shows that the oxidation resistance properties are improved by the second composition, even if this composition is deposited in a lower quantity than the first.

Finally, excellent penetration of the solid composition is observed during the heat treatment steps, for all samples, even those comprising three stages of deposition of a solid composition.

The effect of a protective coating obtained by a method according to the second aspect will now be described, which should not be considered as limiting the invention.

A first experiment according to the second aspect of the invention was performed as described below.

A carbon/carbon composite material part comprising a carbon fiber reinforcement densified by a pyrocarbon matrix was first obtained. The reinforcement was formed by needling oxidized polyacrylonitrile (PAN) fibers and then carbonizing the fibers to form the carbon fiber reinforcement. The thus obtained carbon fiber reinforcement was then densified by chemical vapor infiltration (CVI) to form the pyrocarbon matrix.

An impregnation composition comprising mono-aluminium phosphate Al(H₂PO₄)₃ was then applied on the external surface of the part. The impregnation composition was an aqueous solution of aluminium dihydrogen phosphate concentrated at 50% by weight. The mono-aluminium phosphate Al(H₂PO₄)₃ applied to the external surface of the part had a P/Al atomic ratio of 3,4. This solution is, for example, available under the trade name “aluminum dihydrogen phosphate 50%” from the company Alfa.

The thus applied impregnation composition was then preliminary heated at a temperature of 700 °C for 60 minutes to form an adhesion-promoting layer chemically bonded to the carbon/carbon composite material part and comprising a [A] allotropic form of Al(PO₃)₃.

A solid oxidation-resistant glass composition was then dry deposited after this preliminary heat treatment. The glass composition using in this experiment had the following composition:
67% silicon oxide SiO₂;
7% potassium oxide K₂O;
0.8% sodium oxide Na₂O;
2.9% aluminum oxide Al₂O₃; and
19% boron sesquioxide B₂O₃.

The solid oxidation-resistant glass composition has been deposited by thermal spraying (atmospheric plasma spraying) with the following parameters:

TABLE 3

| | |
|---|---|
| Plasma gas flow rate | 40 |
| (L/min) | |
| H₂ flow rate (L/min) | 15 |
| Intensity (A) | 650 |
| Power (KW) | 85 |
| Torch speeds (mm/s) | 15 |
| Shot distance (mm) | 80 |
| Material flow rate (g/min) | 9 |
| Carrier gas flow rate | 6 |
| (L/min) | |

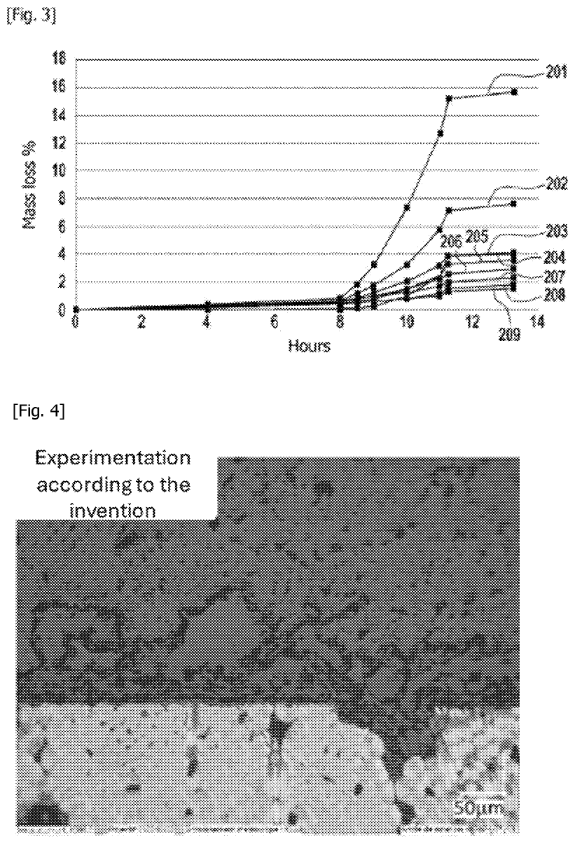

The resulting coated cross-section was examined for adhesion of the glass layer to the substrate. The photograph provided in FIG. 4 shows the result of the carried out experiment.

The oxidation-resistant glass layer (dark region, top) remains fully adhered to the phosphate-treated C/C substrate (light region, bottom). No detachment or gaps are observed at the interface between the glass and the substrate—there are no “black zone” voids, indicating a continuous bond. This excellent adhesion is attributed to the formation of the Al(PO₃)₃ [A] phase, which improved wetting and bonding of the glass.

A second experiment outside the scope of the invention was performed as described below.

The second experiment was identical to the first experiment except concerning the preliminary heat treatment that did not result in the formation of the Al(PO₃)₃ [A] phase, not even in the formation of Al(PO₃)₃. Instead, the phosphate-impregnated sample was only dried at 90 °C for 24 hours (a typical low-temperature cure) and given a brief preheating (80 seconds above 200 °C) immediately before the glass powder deposition.

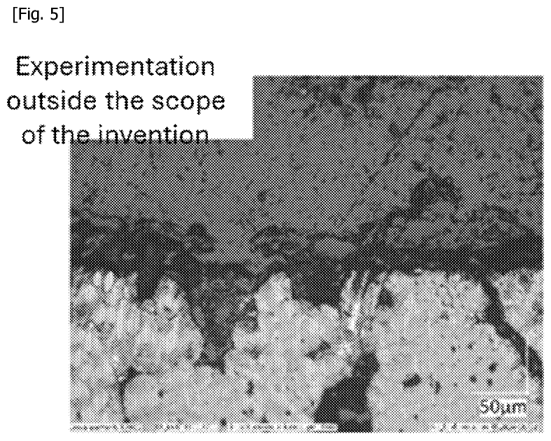

The photograph provided in FIG. 5 shows the carried out experiment outside the scope of the invention.

In this comparative sample, dark patches (“black zones”) are visible along the interface, indicating areas where the glass coating failed to adhere and detached from the substrate. The glass layer (dark region, top) did not bond uniformly to the underlying C/C composite (light region, bottom)—interfacial detachment is evident. These black interfacial voids demonstrate poor adhesion when the phosphate was only low-temperature cured (90 °C) that did not result in the formation of the [A] allotropic form of Al(PO₃)₃. The comparison with the previous photograph highlights that omitting the claimed preheat step results in a markedly inferior bond, with the glass prone to flaking off the carbon substrate.

In both experiments, the glass was deposited by the same thermal spray process; thus the presence or absence the [A] allotropic form of Al(PO₃)₃ is the key factor affecting adhesion. The first experiment, which resulted in the formation of the [A] allotropic form of Al(PO₃)₃, yielded a robust glass-substrate interface with no observable delamination. The second experiment, lacking such allotropic form, showed interface failure (the detached zones appear black in cross-section due to exposed carbon). These results confirm that the [A] metaphosphate phase ensures good glass adherence, whereas a conventional drying regimen is insufficient.

The [A] allotropic form of Al(PO₃)₃ promotes adhesion of the subsequently applied glass layer.

What is claimed is:

1. A method for protecting a carbon/carbon composite material part from oxidation, the method comprising:
applying onto at least a portion of an external surface of the part an impregnation composition comprising mono-aluminium phosphate Al(H₂PO₄)₃;
preliminary heat treating the thus applied impregnation composition to form an adhesion-promoting layer chemically bonded to the carbon/carbon composite material part and comprising a [A] allotropic form of Al(PO₃)₃; and
dry depositing, after performing the preliminary heat treatment, onto at least a portion of the adhesion-promoting layer a solid oxidation-resistant glass composition; said oxidation-resistant glass being chemically bonded to the adhesion-promoting layer comprising the [A] allotropic form of Al(PO₃)₃.

2. The method according to claim 1, wherein the mono-aluminium phosphate Al(H₂PO₄)₃ applied to the external surface of the part has a P/Al atomic ratio that is greater than 3.

3. The method according to claim 2, wherein the P/Al atomic ratio is greater than or equal to 3.2.

4. The method according to claim 1, wherein a temperature comprised between 680 °C and 900 °C is applied during the preliminary heat treatment.

5. The method according to claim 4, wherein the temperature applied during the preliminary heat treatment is between 700 °C and 850 °C.

6. The method according to claim 5, wherein the temperature applied during the preliminary heat treatment is between 700 °C and 750 °C.

7. The method according to claim 1, wherein a quantity of mono-aluminium phosphate Al(H₂PO₄)₃ deposited on the external surface of the part is greater than or equal to 15 mg/cm².

8. The method according to claim 7, wherein the quantity of mono-aluminium phosphate Al(H₂PO₄)₃ deposited on the external surface of the part is comprised between 15 mg/cm² and 25 mg/cm².

9. The method according to claim 1, wherein a quantity of the [A] allotropic form of Al(PO₃)₃ formed onto the external surface of the part, after the preliminary heat treatment, is greater than or equal to 6 mg/cm².

10. The method according claim 9, wherein the quantity of the [A] allotropic form of Al(PO₃)₃ formed onto the external surface of the part, after the preliminary heat treatment, is comprised between 6 mg/cm² and 11 mg/cm².

11. The method according to claim 1, wherein the dry deposition of the solid composition is carried out by electrostatic spraying, by thermal spraying of powder or by cold spraying.

12. The method according to claim 11, wherein the dry deposition of the solid composition is carried out by thermal spraying.

13. The method according to claim 12, wherein the dry deposition of the solid composition is carried out by atmospheric plasma spraying.

14. The method according to claim 1, wherein a quantity of solid composition deposited onto at least a portion of the external surface of the part during the dry deposition step of a solid composition is greater than or equal to 2 mg/cm².

15. The method according to claim 14, wherein the quantity of solid composition deposited onto at least a portion of the external surface of the part during the dry deposition step is comprised between 2 mg/cm² and 10 mg/cm².

16. The method according to claim 1, wherein the solid composition comprises, in mass percentages:
42 to 47% phosphorus pentoxide P₂O₅;
8 to 11% potassium oxide K₂O;
14 to 18% sodium oxide Na₂O;
14 to 18% aluminum oxide Al₂O₃; and
7 to 10% boron sesquioxide B₂O₃,
or wherein the solid composition comprises, in mass percentages:
37 to 41% phosphorus pentoxide P₂O₅;
16 to 20% potassium oxide K₂O;
10 to 13% sodium oxide Na₂O;
16 to 19% aluminum oxide Al₂O₃; and
7.5 to 10.5% boron sesquioxide B₂O₃.

17. The method according to claim 1, wherein the carbon/carbon composite material part is a friction part.

18. The method according to claim 1, wherein the method further comprises performing an impregnation heat treatment in order to soften or melt the dry deposited solid composition, to allow the impregnation of the internal porosity of the part by the composition thus softened or melted, and to form an oxidation-resistant glass in the internal porosity of the part.

19. The method according to claim 18, wherein the oxidation-resistant glass is formed to a depth greater than or equal to 0.5 mm, measured from the external surface of the part.

20. The method according to claim 1, wherein the carbon/carbon composite material part comprises a carbon fiber reinforcement and a pyrocarbon matrix densifying said carbon fiber reinforcement.
